(19) United States
(12) Patent Application Publication
(10) Pub. No.: US 2026/0260022 A1
(43) Pub. Date: Sep. 3, 2026

(54) PRIVACY COMPUTING DEVICE, METHOD AND SYSTEM, AND ELECTRONIC DEVICE AND MEDIUM

(71) Applicant: CHINA UNIONPAY CO., LTD., Shanghai (CN)

(72) Inventors: Yongkai ZHOU, Shanghai (CN); Qi WANG, Shanghai (CN); Zhongzheng CHEN, Shanghai (CN); Shuo HE, Shanghai (CN); Pengfei GAO, Shanghai (CN); Quan SUN, Shanghai (CN); Yanming YANG, Shanghai (CN)

(21) Appl. No.: 18/994,497

(22) PCT Filed: Dec. 7, 2022
(86) PCT No.: PCT/CN2022/137367

§ 371 Date: Jan. 14, 2025

(30) Foreign Application Priority Data
Jul. 15, 2022 (CN) 202210836848.2

(51) Int. Cl. G06F 21/71; G06F 21/62

(52) U.S. Cl. CPC G06F 21/71; G06F 21/6236

(57) ABSTRACT

A privacy computing device includes a determination unit, configured to, when first computing data is obtained after performing corresponding computation on to-be-processed data based on a first sub-algorithm in a privacy algorithm, and when it is determined that the first computing data needs to be recomputed based on a second sub-algorithm in the privacy algorithm, where the second sub-algorithm is stored in another privacy computing device, determine a proxy application programming interface (API) corresponding to the first sub-algorithm and a proxy API corresponding to the second sub-algorithm according to a pre-stored correspondence between sub-algorithms and proxy APIs; and a transmission unit, configured to send the first computing data to the proxy API corresponding to the second sub-algorithm through the proxy API corresponding to the first sub-algorithm, so that the other privacy computing device performs corresponding computation on first computing data based on the second sub-algorithm.

### CROSS-REFERENCE TO RELATED APPLICATION

This application claims priority to Chinese Patent Application No. 202210836848.2, entitled “PRIVACY COMPUTING DEVICE, METHOD AND SYSTEM, AND ELECTRONIC DEVICE AND MEDIUM,” filed on Jul. 15, 2022, the entire content of which is incorporated herein by reference.

### FIELD OF THE DISCLOSURE

The present disclosure generally relates to the field of network security technology and, more particularly, relates to a privacy computing device, method, system, electronic device and medium.

### BACKGROUND

Privacy computing (or privacy compute) refers to a collection of technologies that realize data analysis and computation on the premise of protecting the data from being leaked to the outside world, to achieve the objective of “available but invisible data”, which then allows to achieve data value transformation and release on the premise of full data and privacy security protection.

With the increasing awareness of data protection in the relevant fields and the tightening of privacy regulatory policies, privacy computing has received widespread attention in the relevant fields due to its “available but invisible” feature. Many technology companies have launched their own privacy computing products with fields-related features. A large variety of privacy computing products have enriched market choices and also brought new challenges. For example, privacy computing products launched by different technology companies are usually designed and implemented based on different system platforms. When the privacy computing products of different system platforms are stored in different privacy computing devices, it is generally impossible to complete the interaction of information between privacy computing products of different system platforms, which then turns “data islands” into “computing islands”. In addition, even if the same privacy computing product is launched by the same technology company, when the same privacy computing product is stored in different privacy computing devices, the interaction of information between the same privacy computing product in different devices is usually impossible, which also turns a “data island” into a “computing island”.

Therefore, the problem of interconnection and interoperability between privacy algorithm products stored in different privacy computing devices has become an absolute pain point in the relevant fields. How to achieve interconnection and interoperability between privacy algorithm products stored in different privacy computing devices is a technical problem that needs to be urgently addressed currently.

### SUMMARY

The disclosure provides a privacy computing device, method, system, device and medium for realizing interconnection and interoperability between privacy algorithm products stored in different privacy computing devices.

In a first aspect, the disclosure provides a privacy computing device, which includes: a determination unit, configured to, when first computing data is obtained after performing corresponding computation on to-be-processed data based on a first sub-algorithm in a privacy algorithm, and when it is determined the first computing data needs to be recomputed based on a second sub-algorithm in the privacy algorithm, where the second sub-algorithm is stored in another privacy computing device, determine a proxy API corresponding to the first sub-algorithm and a proxy API corresponding to the second sub-algorithm according to a pre-stored correspondence between sub-algorithms and proxy APIs; and a transmission unit, configured to send the first computing data to the proxy API corresponding to the second sub-algorithm through the proxy API corresponding to the first sub-algorithm, so that the other privacy computing device performs corresponding computation on the first computing data based on the second sub-algorithm.

In some embodiments, the determination unit includes: a scene algorithm module, configured to send the to-be-processed data to a security algorithm module; and the security algorithm module, configured to receive the to-be-processed data, and perform the corresponding computation on the to-be-processed data based on a security algorithm included in the first sub-algorithm to obtain the first computing data.

In some embodiments, the scene algorithm module is further configured to determine a security algorithm API corresponding to the scene algorithm included in the first sub-algorithm based on a pre-stored correspondence between scene algorithms and security algorithm APIs, and send the to-be-processed data to the security algorithm module based on the security algorithm API corresponding to the scene algorithm.

In some embodiments, the security algorithm module is further configured to send the first computing data to the scene algorithm module; and the scene algorithm module is further configured to send the first computing data to the transmission unit.

In some embodiments, the scene algorithm module is further configured to determine a transmission layer API corresponding to the first sub-algorithm according to a pre-stored correspondence between sub-algorithms and transmission layer APIs, and send the first computing data to the transmission unit through the transmission layer API corresponding to the first sub-algorithm.

In some embodiments, the security algorithm module is further configured to send the first computing data to the transmission unit.

In some embodiments, the security algorithm module is further configured to determine a transmission layer API corresponding to the first sub-algorithm based on a pre-stored correspondence between sub-algorithms and transmission layer APIs, and send the first computing data to the transmission unit through the transmission layer API corresponding to the first sub-algorithm.

In some embodiments, the determination unit is further configured to, when receiving a transmission instruction to send the first computing data, determine that the first computing data needs to be re-calculated based on the second sub-algorithm in the privacy algorithm, where the transmission instruction carries information that the first computing data needs to be sent to the second sub-algorithm.

In some embodiments, the transmission unit is further configured to, when second computing data is received based on the proxy API corresponding to the first sub-algorithm, send the second computing data to the determination unit; and the determination unit is further configured to perform corresponding computation on the second computing data based on the first sub-algorithm when it is determined that the second computing data needs to be recomputed based on the first sub-algorithm.

In some embodiments, the transmission unit is further configured to, when the second computing data is received, send the second computing data to the determination unit through the transmission layer API corresponding to the first sub-algorithm.

In some embodiments, the scene algorithm module in the determination unit is further configured to receive the second computing data and send the second computing data to the security algorithm module; and the security algorithm module in the determination unit is further configured to receive the second computing data, and perform the corresponding computation on the second computing data based on the security algorithm included in the first sub-algorithm.

In some embodiments, the scene algorithm module is further configured to determine a security algorithm API corresponding to the scene algorithm included in the first sub-algorithm according to the pre-stored correspondence between the scene algorithms and the security algorithm APIs, and send the second computing data to the security algorithm module based on the security algorithm API corresponding to the scene algorithm.

In some embodiments, the determination unit is further configured to determine that the second computing data needs to be recomputed based on the first sub-algorithm, when receiving a processing instruction that the second computing data needs to be processed based on the first sub-algorithm.

In some embodiments, the determination unit is further configured to identify a target token carried in the processing instruction, and determine that the second computing data needs to be recomputed based on the first sub-algorithm when the target token is consistent with a pre-stored reference token of the second sub-algorithm.

In some embodiments, the first sub-algorithm and the second sub-algorithm are container-structured algorithms.

In a second aspect, the disclosure provides a privacy computing method, which includes: when first computing data is obtained after performing corresponding computation on to-be-processed data based on a first sub-algorithm in a privacy algorithm, and when it is determined that the first computing data needs to be recomputed based on a second sub-algorithm in the privacy algorithm, where the second sub-algorithm is stored in another privacy computing device, determining a proxy application programming interface (API) corresponding to the first sub-algorithm and a proxy API corresponding to the second sub-algorithm based on a pre-stored correspondence between sub-algorithms and proxy APIs; and transmitting the first computing data to the proxy API corresponding to the second sub-algorithm through the proxy API corresponding to the first sub-algorithm, so that the other privacy computing device performs corresponding computation on the first computing data based on the second sub-algorithm.

In some embodiments, before determining that the first computing data needs to be recomputed based on the second sub-algorithm in the privacy algorithm, the method further includes: receiving a transmission instruction for transmitting the first computing data, where the transmission instruction carries information that the first computing data needs to be sent to the second sub-algorithm.

In some embodiments, the method further includes: when second computing data is received based on the proxy API corresponding to the first sub-algorithm, and when it is determined that the second computing data needs to be recomputed based on the first sub-algorithm, performing corresponding computation on the second computing data based on the first sub-algorithm.

In some embodiments, before determining that the second computing data needs to be recomputed based on the first sub-algorithm, the method further includes: receiving a processing instruction that the second computing data needs to be processed based on the first sub-algorithm.

In some embodiments, after receiving the processing instruction that the second computing data needs to be processed based on the first sub-algorithm and before determining that the second computing data needs to be recomputed based on the first sub-algorithm, the method further includes: identifying a target token carried in the processing instruction, and when the target token is consistent with a pre-stored reference token of the second sub-algorithm, determining that the second computing data needs to be recomputed based on the first sub-algorithm.

In a third aspect, the disclosure provides a privacy computing system, which includes: a first privacy computing device, configured to, when first computing data is obtained after performing corresponding computation on to-be-processed data based on a first sub-algorithm in a privacy algorithm, and when it is determined that that the first computing data needs to be recomputed based on a second sub-algorithm in the privacy algorithm, where the first sub-algorithm and the second sub-algorithm is stored in a second privacy computing device, determine a proxy application programming interface (API) corresponding to the first sub-algorithm and a proxy API corresponding to the second sub-algorithm according to a pre-stored correspondence between sub-algorithms and proxy APIs, and send the first computing data to the proxy API corresponding to the second sub-algorithm through the proxy API corresponding to the first sub-algorithm; and the second privacy computing device, configured to, when receiving the first computing data based on the proxy API corresponding to the second sub-algorithm, and when it is determined that the first computing data needs to be recomputed based on the second sub-algorithm, perform corresponding computation on the first computing data based on the second sub-algorithm.

In a fourth aspect, the disclosure provides an electronic device, which includes a processor and a memory, where the memory stores program code, and when the program code is executed by the processor, the processor is configured to execute the steps of the disclosed privacy computing methods.

In a fifth aspect, the disclosure provides a computer-readable storage medium, which includes program code. When the storage medium is run on an electronic device, the program code is configured to cause the electronic device to execute the steps of the disclosed privacy computing methods.

In a sixth aspect, the present disclosure provides a computer program product. The computer program product includes: computer program code. When the computer program code is run on a computer, it causes the computer to execute the steps of the disclosed privacy computing methods.

In the present disclosure, the determination unit in a privacy computing device obtains first computing data after performing corresponding computation on to-be-processed data based on the first sub-algorithm in the privacy algorithm, and determines that the first computing data needs to be recalculated based on the second sub-algorithm in the privacy algorithm, where the second sub-algorithm is stored in another privacy computing device. The proxy API corresponding to the first sub-algorithm and the proxy API corresponding to the second sub-algorithm are then determined according to the pre-stored correspondence between sub-algorithms and the proxy APIs. In this way, the transmission unit in the privacy computing device can send the first computing data to the proxy API corresponding to the second sub-algorithm through the proxy API corresponding to the first sub-algorithm, so that the other privacy computing device can perform corresponding computation on the first computing data based on the second sub-algorithm. This then allows the first sub-algorithm and the second sub-algorithm (i.e., privacy algorithm products stored in different privacy computing devices) to interact with each other, to achieve the purpose of interconnection and interoperability between privacy algorithm products stored in different privacy computing devices.

### BRIEF DESCRIPTION OF THE DRAWINGS

In order to more clearly explain the embodiments of the present disclosure or the implementation of related technologies, the following will briefly introduce the drawings that are essential for the understanding of the embodiments or related technologies. Apparently, the drawings in the following description are merely some of the present disclosure. For those of ordinary skill in the art, other drawings may also be obtained based on these drawings.

FIG. 1 shows a schematic structural diagram of a first privacy computing device according to some embodiments;

FIG. 2 shows a schematic structural diagram of a second privacy computing device according to some embodiments;

FIG. 3 shows a schematic diagram of a first interconnection and interoperability process between different privacy algorithms according to some embodiments;

FIG. 4 shows a schematic diagram of a second interconnection and interoperability process between different privacy algorithms according to some embodiments;

FIG. 5 shows a schematic diagram of a third interconnection and interoperability process between different privacy algorithms according to some embodiments;

FIG. 6 shows a schematic diagram of a fourth interconnection and interoperability process between different privacy algorithms according to some embodiments;

FIG. 7 shows a schematic diagram of an interconnection scenario of different privacy algorithms according to some embodiments;

FIG. 8 shows a schematic diagram of a fifth interconnection and interoperability process between different privacy algorithms according to some embodiments;

FIG. 9 shows a flowchart of a privacy computing method according to some embodiments;

FIG. 10 shows a schematic diagram of a privacy computing system according to some embodiments; and

FIG. 11 shows a schematic structural diagram of an electronic device according to some embodiments.

### DETAILED DESCRIPTION

In order to realize interconnection and interoperability between privacy algorithm products stored in different privacy computing devices, the present disclosure provides a privacy computing device, method, system, device and medium.

In order to make the purpose and implementation of the present disclosure clearer, the exemplary embodiments of the present disclosure will be clearly and thoroughly described hereinafter in conjunction with the accompanying drawings in the exemplary embodiments of the present disclosure. Apparently, the described exemplary embodiments are merely some of the embodiments of the disclosure, but not all of the embodiments.

It should be noted that the brief description of terms in the disclosure is merely to facilitate understanding of the embodiments described herein, and is not intended to limit the embodiments of the disclosure. Unless otherwise stated, these terms should be understood according to their ordinary and general meaning.

The terms “first”, “second”, “third”, etc., in the description and claims of the disclosure and the drawings are intended to distinguish same or similar objects or entities, and do not necessarily mean to limit specific sequences or sequential order unless otherwise noted. It should be understood that the terms so used are interchangeable under appropriate circumstances.

The terms “include” and “comprise” and any variations thereof are intended to cover but not exclusively include. For example, a product or device that includes a list of components need not be limited to all components expressly listed, but may include a component not expressly listed, or other components inherent to these products or devices.

The term “module” means a known or later developed hardware, software, firmware, artificial intelligence, fuzzy logic or combination of hardware or/and software code capable of performing the functions associated with that element.

Further, it should be noted that the disclosed embodiments are merely used to illustrate the technical solution of the present disclosure, but not to limit the disclosure. Although the present disclosure has been described in detail with reference to these embodiments, those of ordinary skill in the art should understand that the technical solution described in these embodiments may still be modified, or some or all of the technical features may be equivalently substituted. These modifications or substitutions do not deviate the essence of the corresponding technical solutions from the scope of the technical solution of the embodiments of the present disclosure.

### Embodiment 1

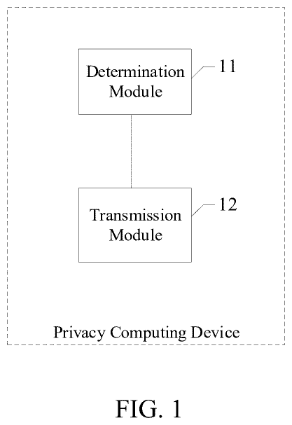

FIG. 1 shows a schematic structural diagram of a first privacy computing device according to some embodiments. The device includes: a determination unit 11 and a transmission unit 12.

The determination unit 11 is configured to, when first computing data is obtained after performing corresponding computation on to-be-processed data based on a first sub-algorithm in a privacy algorithm, and when it is determined that the first computing data needs to be recomputed based on a second sub-algorithm in the privacy algorithm, where the second sub-algorithm is saved in another privacy computing device, determine a proxy application programming interface (API) corresponding to the first sub-algorithm and a proxy API corresponding to the second sub-algorithm based on a pre-stored correspondence between sub-algorithms and proxy APIs.

The transmission unit 12 is configured to send the first computing data to the proxy API corresponding to the second sub-algorithm through the proxy API corresponding to the first sub-algorithm, so that the other privacy computing device can perform corresponding computation on the first computing data based on the second sub-algorithm.

In some embodiments, the privacy computing device may be a device such as a PC, a mobile terminal, and the like, or may be a device such as a server and the like, which is not specifically limited in the disclosure. The determination unit 11 and the transmission unit 12 in the privacy computing device are connected. The disclosure does not specifically limit the connection methods of the determination unit 11 with the transmission unit 12.

In some embodiments, the first sub-algorithm of a privacy algorithm is stored in the privacy computing device (for convenience of description, the sub-algorithm stored in this privacy computing device is referred to as the first sub-algorithm), and the second sub-algorithm of the same privacy algorithm is stored in another privacy computing device (for convenience of description, the sub-algorithm stored in another privacy computing device is referred to as the second sub-algorithm). In some embodiments, the first sub-algorithm and the second sub-algorithm may respectively be part of the sub-algorithms included in the same privacy computing product launched by the same technology company. Optionally, the first sub-algorithm and the second sub-algorithm may also be different privacy computing products launched by different technology companies based on different system platforms, which may be flexibly set according to needs, and is not limited in the disclosure. In some embodiments, the number of other privacy computing devices may be one or multiple. The disclosure does not specifically limit the number of other privacy computing devices, which may be flexibly set according to needs. Regardless of the number of other privacy computing devices, whether the number is one or more, for each another privacy computing device, the privacy computing process provided by the embodiments of the disclosure may be used for interconnection and interoperability between the privacy computing device and the privacy algorithm product stored in the other privacy computing device, the specific detail of which will not be described hereinafter.

In some embodiments, the determination unit 11 in the privacy computing device may perform corresponding computation on the to-be-processed data based on the first sub-algorithm to obtain the first computing data (for convenience of description, the computing data obtained based on the first sub-algorithm may be referred to as the first computing data). The disclosure does not specifically limit the computing method of the to-be-processed data by the first sub-algorithm. The first computing data may be an intermediate computing result of the to-be-processed data by the first sub-algorithm, or may be the final computing result of the to-be-processed data by the first sub-algorithm, etc.

In some embodiments, when the determination unit 11 obtains the first computing data after performing corresponding computation on the to-be-processed data based on the first sub-algorithm, the determination unit 11 may determine whether the first computing data needs to recomputed be based on a second sub-algorithm stored in another privacy computing device. For convenience of description, the privacy computing device that stores the first sub-algorithm is referred to as the first privacy computing device, and the other privacy computing device that stores the second sub-algorithm is referred to as the second privacy computing device.

In some embodiments, the first sub-algorithm and the second sub-algorithm may be run based on a predetermined privacy algorithm protocol. For example, when the first computing data needs to be recomputed based on the second sub-algorithm, the determination unit 11 in the first privacy computing device may receive a transmission instruction to send the first computing data. The transmission instruction may carry information that the first computing data needs to be sent to the second sub-algorithm. When the determination unit 11 receives the transmission instruction, the determination unit 11 may determine that the first computing data needs to be recomputed based on the second sub-algorithm.

In some embodiments, when it is determined that the first computing data needs to be recomputed based on the second sub-algorithm, in order to send the first computing data to the second sub-algorithm, the correspondence between sub-algorithms and proxy APIs may be stored in advance in the determination unit 11, in which a sub-algorithm and the corresponding proxy API may be flexibly set according to needs, which is not limited in the present disclosure. The determination unit 11 may determine the proxy API corresponding to the first sub-algorithm according to the pre-stored correspondence between sub-algorithms and proxy APIs. In addition, the determination unit 11 may also determine the proxy API corresponding to the second sub-algorithm based on the pre-stored correspondence between sub-algorithms and proxy APIs.

After determining the proxy API corresponding to the first sub-algorithm and the proxy API corresponding to the second sub-algorithm, the transmission unit 12 in the privacy computing device (i.e., first privacy computing device) may use the proxy API corresponding to the first sub-algorithm to send the first computing data to the proxy API corresponding to the second sub-algorithm in another privacy computing device (i.e., second privacy computing devices), so that the second sub-algorithm stored in the other privacy computing device may perform corresponding computation on the first computing data, so that the first computing data may be computed accordingly. This enables information exchange between the first sub-algorithm and the second sub-algorithm (i.e., between privacy algorithm products stored in different privacy computing devices), thereby achieving the purpose of interconnection and interoperability between privacy algorithm products stored in different privacy computing devices. Optionally, the proxy API corresponding to the first sub-algorithm and the proxy API corresponding to the second sub-algorithm may be representational state transfer (RESTful) API, etc.

In the present disclosure, the determination unit in the privacy computing device obtains the first computing data after performing corresponding computation on the to-be-processed data based on the first sub-algorithm in the privacy algorithm, determines that the first computing data needs to be recomputed based on the second sub-algorithm in the privacy algorithm, where the second sub-algorithm is stored in another privacy computing device, and then determine the proxy API corresponding to the first sub-algorithm and the proxy API corresponding to the second sub-algorithm based on the pre-stored correspondence between sub-algorithms and proxy APIs. The transmission unit in the privacy computing device may send the first computing data to the proxy API corresponding to the second sub-algorithm through the proxy API corresponding to the first sub-algorithm, so that the other privacy computing device may perform corresponding computation on the first computing data based on the second sub-algorithm. This then allows information to be exchanged between the first sub-algorithm and the second sub-algorithm (i.e., privacy algorithm products stored in different privacy computing devices), thereby achieving the purpose of interconnection and interoperability between the privacy algorithm products stored in different privacy computing devices.

### Embodiment 2

In order to flexibly and accurately perform privacy computation on the to-be-processed data, based on the above embodiments, in the embodiments disclosed herein, the determination unit 11 includes: a scene algorithm module, configured to send the to-be-processed data to a security algorithm module; and the security algorithm module, configured to receive the to-be-processed data, and perform corresponding computation on the to-be-processed data based on the security algorithm included in the saved first sub-algorithm to obtain the first computing data.

In some embodiments, in order to increase the flexibility and accuracy of privacy computing, a privacy algorithm such as the first sub-algorithm and the second sub-algorithm may be decoupled to include a scene algorithm and a security algorithm. Here, if a privacy algorithm does not contain a security algorithm and just contains a scene algorithm, a computation may be considered to be a plaintext computation on the to-be-processed data without security encryption protection. If the privacy algorithm contains a scene algorithm and a security algorithm, the computation may be considered as a privacy computation on the to-be-processed data under secure encryption protection. Here, the scene algorithm may be the horizontal and vertical logistic regression (LR), XGBoost algorithm, and the like within federated learning. The security algorithm may refer to cryptographic algorithm operations, multi-party security computing, or other algorithms that perform certain cryptographic primitive operations on data. Whether a privacy algorithm includes a scene algorithm and/or a security algorithm may be flexibly selected according to needs, which is not limited in the disclosure.

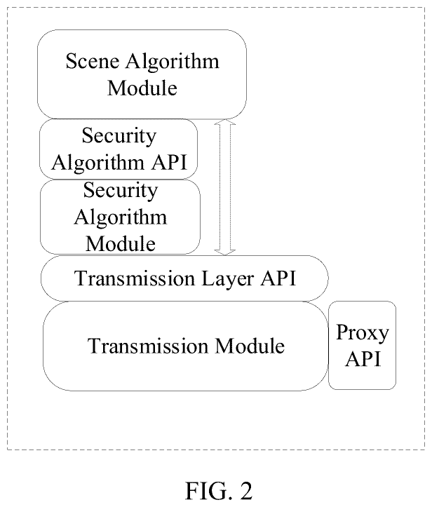

FIG. 2 shows a schematic structural diagram of the second privacy computing device according to some embodiments. Optionally, the first sub-algorithm may be decoupled to include a scene algorithm and a security algorithm. The included scene algorithm is stored in the scene algorithm module in the determination unit 11, and the security algorithm included in the first sub-algorithm is stored in the security algorithm module in the determination unit 11.

In some embodiments, the process of obtaining the first computing data after performing corresponding computation on the to-be-processed data based on the first sub-algorithm is as follows.

In order to flexibly and accurately determine the security algorithm included in the first sub-algorithm, the correspondence between scene algorithms and security algorithm APIs may be stored in advance. A first scene algorithm module may determine a security algorithm API corresponding to the scene algorithm included in the first sub-algorithm based on the pre-stored correspondence between the scene algorithms and the security algorithm APIs.

Next, through the security algorithm API corresponding to the scene algorithm included in the first sub-algorithm, the scene algorithm included in the first sub-algorithm may call the security algorithm included in the first sub-algorithm. Accordingly, based on the security algorithm included in the first sub-algorithm, privacy computing may be performed on the to-be-processed data under secure encryption protection to obtain the first computing data. Optionally, when calling the security algorithm included in the first sub-algorithm, the scene algorithm module may send the to-be-processed data to the security algorithm module based on the security algorithm API corresponding to the scene algorithm included in the first sub-algorithm. The security algorithm module receives the to-be-processed data, and may perform a corresponding privacy computation on the to-be-processed data based on the security algorithm included in the saved first sub-algorithm to obtain the first computing data.

Compared with the highly coupled scene algorithm and security algorithm included in a privacy algorithm, the disclosure may decouple a privacy algorithm into a scene algorithm and a security algorithm, so that a trusted security algorithm may be freely selected for the privacy algorithm, which improves the flexibility and security of the privacy algorithm.

In addition, compared with a privacy algorithm that also contains a highly coupled transmission unit 12, each time the privacy algorithm is loaded, its corresponding transmission unit 12 needs to be loaded, resulting in inefficient system implementation. The disclosure may use a transmission unit 12 decoupled from the privacy algorithm, the privacy algorithm may not include the coupled transmission unit 12, but the transmission unit 12 is configured in the privacy computing device, such as in the platform base of the privacy computing device and the like, which improves the standardization and diversity of the privacy algorithm. Moreover, when loading the privacy algorithm, one just needs to load the scene algorithm and security algorithm included in the privacy algorithm. There is no need to load the transmission components related to the corresponding transmission unit 12 or load the transmission components with an unknown degree of trust, thereby improving the overall performance of the system, while also improving security.

In addition, since the proxy APIs, security algorithm APIs, transmission layer APIs, and so on in the disclosure may all be standard APIs, the flow and call of data in a privacy computing process may be tracked and monitored, which may improve the controllability of privacy computing. This may well meet the requirements of the privacy algorithm for safe and controllable data operations, and also has the feature of safe replaceability and flexible combination between a scene algorithm and a security algorithm, and between a privacy algorithm and a transmission unit 12.

In order to quickly and flexibly send the first computing data to the transmission unit 12, on the basis of the above embodiments, the embodiments of the present disclosure provide two methods to send the first computing data to the transmission unit 12.

The first method: Exemplarily, when the security algorithm included in the first sub-algorithm is simple encryption or homomorphic encryption (HE), etc., after obtaining the first computing data, the security algorithm module may send the first computing data to the scene algorithm module, which sends the first computing data to the transmission unit 12. In some embodiments, when the scene algorithm module sends the first computing data to the transmission unit 12, the scene algorithm module may determine a transmission layer API corresponding to the first sub-algorithm based on a pre-stored correspondence between sub-algorithms and transmission layer APIs, and send the first computing data to the transmission unit 12 through a transmission layer API corresponding to the first sub-algorithm.

The second method: Exemplarily, when the security algorithm included in the first sub-algorithm is secure multi-party computation (MPC) and the like, the security algorithm module may directly determine the transmission layer API corresponding to the first sub-algorithm based on the pre-stored correspondence between sub-algorithms and transmission layer APIs, and send the first computing data to the transmission unit 12 through the transmission layer API corresponding to the first sub-algorithm.

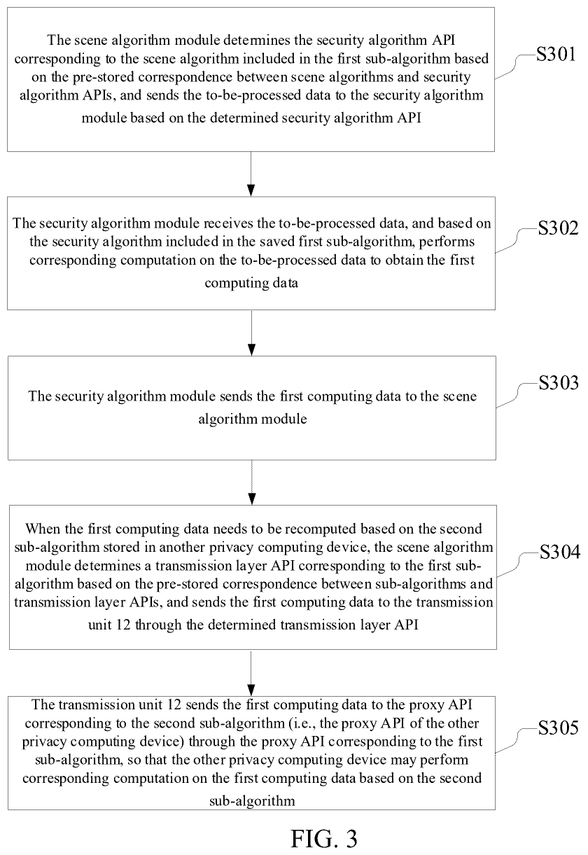

To facilitate understanding, the interconnection and interoperability process between different privacy algorithms provided by the disclosure will be described below through a specific embodiment. FIG. 3 shows a schematic diagram of a first interconnection and interoperability process between different privacy algorithms according to some embodiments.

As shown in FIG. 3, the process includes the following steps.
S301: The scene algorithm module determines the security algorithm API corresponding to the scene algorithm included in the first sub-algorithm based on the pre-stored correspondence between scene algorithms and security algorithm APIs, and sends the to-be-processed data to the security algorithm module based on the determined security algorithm API.
S302: The security algorithm module receives the to-be-processed data, and based on the security algorithm included in the saved first sub-algorithm, performs corresponding computation on the to-be-processed data to obtain the first computing data.
S303: The security algorithm module sends the first computing data to the scene algorithm module.
S304: When the first computing data needs to be recomputed based on the second sub-algorithm stored in another privacy computing device, the scene algorithm module determines a transmission layer API corresponding to the first sub-algorithm based on the pre-stored correspondence between sub-algorithms and transmission layer APIs, and sends the first computing data to the transmission unit 12 through the determined transmission layer API.
S305: The transmission unit 12 sends the first computing data to the proxy API corresponding to the second sub-algorithm (i.e., the proxy API of the other privacy computing device) through the proxy API corresponding to the first sub-algorithm, so that the other privacy computing device may perform corresponding computation on the first computing data based on the second sub-algorithm.

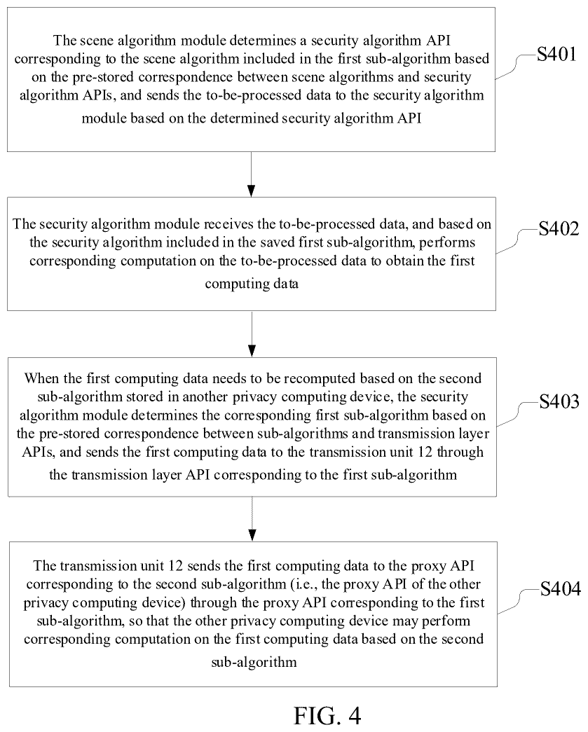

To facilitate understanding, the interconnection and interoperability process between different privacy algorithms provided by the disclosure will be described below through another specific embodiment. FIG. 4 shows a schematic diagram of a second interconnection and interoperability process between different privacy algorithms according to some embodiments. As shown in FIG. 4, the process includes the following steps.
S401: The scene algorithm module determines a security algorithm API corresponding to the scene algorithm included in the first sub-algorithm based on the pre-stored correspondence between scene algorithms and security algorithm APIs, and sends the to-be-processed data to the security algorithm module based on the determined security algorithm API.
S402: The security algorithm module receives the to-be-processed data, and based on the security algorithm included in the saved first sub-algorithm, performs corresponding computation on the to-be-processed data to obtain the first computing data.
S403: When the first computing data needs to be recomputed based on the second sub-algorithm stored in another privacy computing device, the security algorithm module determines the corresponding first sub-algorithm based on the pre-stored correspondence between sub-algorithms and transmission layer APIs, and sends the first computing data to the transmission unit 12 through the transmission layer API corresponding to the first sub-algorithm.
S404: The transmission unit 12 sends the first computing data to the proxy API corresponding to the second sub-algorithm (i.e., the proxy API of the other privacy computing device) through the proxy API corresponding to the first sub-algorithm, so that the other privacy computing device may perform corresponding computation on the first computing data based on the second sub-algorithm.

### Embodiment 3

In some embodiments, the privacy computing device (i.e., the first privacy computing device) may not only send the obtained first computing data to another privacy computing device, so that the second sub-algorithm saved in the other privacy computing device (i.e., the second privacy computing device) recomputes the first computing data, but also receive second computing data sent by the other privacy computing device (for convenience of description, the computing data sent by the other privacy computing device is referred to as the second computing data), and recompute the second computing data.

Specifically, the transmission unit 12 in the first privacy computing device may receive the second computing data sent by the other privacy computing device based on the proxy API corresponding to the first sub-algorithm, and may send the second computing data to the determination unit 11. The determination unit 11 may determine whether the second computing data needs to be recomputed based on the first sub-algorithm. When it is determined that the second computing data needs to be recomputed based on the first sub-algorithm, the first privacy computing device may perform corresponding computation on the second computing data based on the first sub-algorithm.

In some embodiments, when determining whether the second computing data needs to be recomputed based on the first sub-algorithm, the determination unit 11 may determine whether it has received a processing instruction that the second computing data needs to be processed based on the first sub-algorithm. When such a processing instruction is received, it may be determined that the second computing data needs to be recomputed based on the first sub-algorithm.

In some embodiments, when the first sub-algorithm and the second sub-algorithm are preparing for interconnection and interoperability in advance, the privacy computing device where the first sub-algorithm is located may save a reference token and the like of the second sub-algorithm. Similarly, a reference token and the like of the first sub-algorithm may also be stored in a privacy computing device where the second sub-algorithm is located. When the privacy computing device where the second sub-algorithm is located sends the second computing data to the privacy computing device where the first sub-algorithm is located, a processing instruction that the second computing data needs to be processed data based on the first sub-algorithm may be sent at the same time. The processing instruction may carry a token of the second sub-algorithm (for convenience of description, the token carried in the processing instruction is referred to as the target token). After the privacy computing device where the first sub-algorithm is located receives the processing instruction, it may determine whether the target token carried in the processing instruction is consistent with the pre-stored reference token of the second sub-algorithm. When the received target token and the pre-stored reference token are consistent, the second computing data may be considered to be sent by a secure compliance device, and it may be determined that the second computing data needs to be recomputed based on the first sub-algorithm. When the target token is inconsistent with the pre-stored reference token of the second sub-algorithm, it may be determined that the second computing data is not sent by a secure compliance device, and it may be determined that there is no need to recalculate the second computing data based on the first sub-algorithm. This may ensure the security of the privacy algorithm products stored in different privacy computing devices in the interconnection and interoperability.

In some embodiments, the transmission unit 12 of the first privacy computing device may include a transmission module, and the determination unit 11 may include a scene algorithm module and a security algorithm module. When the transmission unit 12 sends the second computing data to the determination unit 11, the transmission module may first receive the second computing data based on the proxy API in the transmission unit 12 (i.e., the proxy API corresponding to the first sub-algorithm), and then send the second computing data to the scene algorithm module in the determination unit 11 through the transmission layer API corresponding to the first sub-algorithm. When the scene algorithm module receives the second computing data, the scene algorithm module may send the second computing data to the security algorithm module. Optionally, the scene algorithm module may determine the security algorithm API corresponding to the scene algorithm included in the first sub-algorithm based on the pre-stored correspondence between scene algorithms and security algorithm APIs, and send the second computing data to the security algorithm module based on the determined security algorithm API. When the security algorithm module receives the second computing data, the security algorithm module may perform corresponding computation on the second computing data based on the security algorithm included in the saved first sub-algorithm.

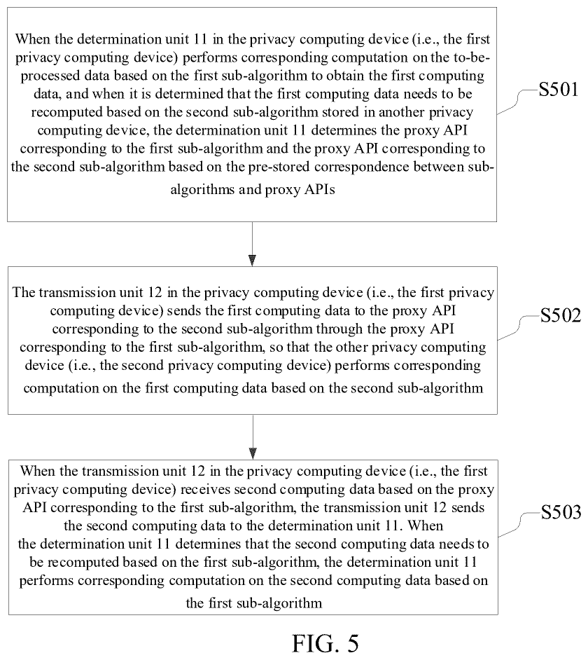

To facilitate understanding, the interconnection and interoperability process between different privacy algorithms provided by the disclosure will be described below through another specific embodiment. FIG. 5 shows a schematic diagram of a third interconnection and interoperability process between different privacy algorithms according to some embodiments. As shown in FIG. 5, the process includes the following steps.
S501: When the determination unit 11 in the privacy computing device (i.e., the first privacy computing device) performs corresponding computation on the to-be-processed data based on the first sub-algorithm to obtain the first computing data, and when it is determined that the first computing data needs to be recomputed based on the second sub-algorithm stored in another privacy computing device, the determination unit 11 determines the proxy API corresponding to the first sub-algorithm and the proxy API corresponding to the second sub-algorithm based on the pre-stored correspondence between sub-algorithms and proxy APIs.
S502: The transmission unit 12 in the privacy computing device (i.e., the first privacy computing device) sends the first computing data to the proxy API corresponding to the second sub-algorithm through the proxy API corresponding to the first sub-algorithm, so that the other privacy computing device (i.e., the second privacy computing device) performs corresponding computation on the first computing data based on the second sub-algorithm.
S503: When the transmission unit 12 in the privacy computing device (i.e., the first privacy computing device) receives second computing data based on the proxy API corresponding to the first sub-algorithm, the transmission unit 12 sends the second computing data to the determination unit 11. When the determination unit 11 determines that the second computing data needs to be recomputed based on the first sub-algorithm, the determination unit 11 performs corresponding computation on the second computing data based on the first sub-algorithm.

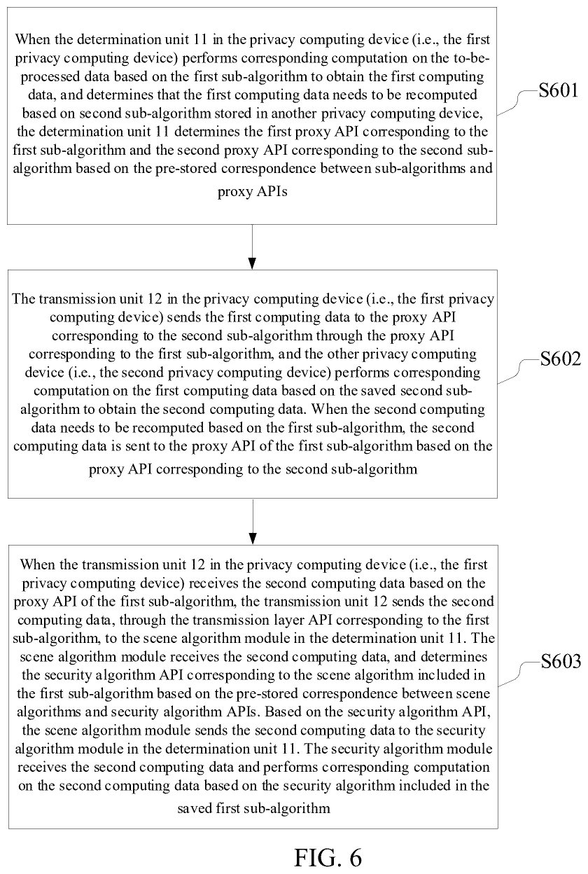

To facilitate understanding, the interconnection and interoperability process between different privacy algorithms provided by the disclosure will be described below through another specific embodiment. FIG. 6 shows a schematic diagram of a fourth interconnection and interoperability process between different privacy algorithms according to some embodiments. As shown in FIG. 6, the process includes the following steps.
S601: When the determination unit 11 in the privacy computing device (i.e., the first privacy computing device) performs corresponding computation on the to-be-processed data based on the first sub-algorithm to obtain the first computing data, and determines that the first computing data needs to be recomputed based on second sub-algorithm stored in another privacy computing device, the determination unit 11 determines the first proxy API corresponding to the first sub-algorithm and the second proxy API corresponding to the second sub-algorithm based on the pre-stored correspondence between sub-algorithms and proxy APIs.
S602: The transmission unit 12 in the privacy computing device (i.e., the first privacy computing device) sends the first computing data to the proxy API corresponding to the second sub-algorithm through the proxy API corresponding to the first sub-algorithm, and the other privacy computing device (i.e., the second privacy computing device) performs corresponding computation on the first computing data based on the saved second sub-algorithm to obtain the second computing data. When the second computing data needs to be recomputed based on the first sub-algorithm, the second computing data is sent to the proxy API of the first sub-algorithm based on the proxy API corresponding to the second sub-algorithm.
S603: When the transmission unit 12 in the privacy computing device (i.e., the first privacy computing device) receives the second computing data based on the proxy API of the first sub-algorithm, the transmission unit 12 sends the second computing data, through the transmission layer API corresponding to the first sub-algorithm, to the scene algorithm module in the determination unit 11. The scene algorithm module receives the second computing data, and determines the security algorithm API corresponding to the scene algorithm included in the first sub-algorithm based on the pre-stored correspondence between scene algorithms and security algorithm APIs. Based on the security algorithm API, the scene algorithm module sends the second computing data to the security algorithm module in the determination unit 11. The security algorithm module receives the second computing data and performs corresponding computation on the second computing data based on the security algorithm included in the saved first sub-algorithm.

In some embodiments, in order to achieve interconnection and interoperability between privacy algorithm products stored in different privacy computing devices, different privacy computing products (e.g., privacy algorithms), such as the first sub-algorithm and the second sub-algorithm, may be both configured to be an algorithm with a container structure. For example, the first sub-algorithm and the second sub-algorithm may both be algorithms with a container structure. Configuring a privacy algorithm as a container structure may make the interconnection and interoperability between different privacy algorithm products stored in different privacy computing devices have good compatibility and operability, and may be accepted by most current mainstream privacy algorithms.

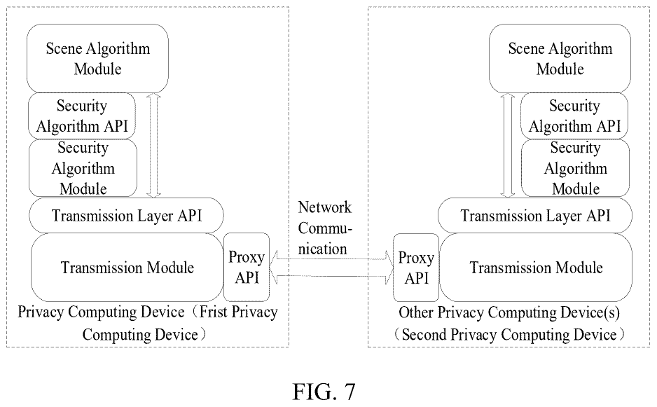

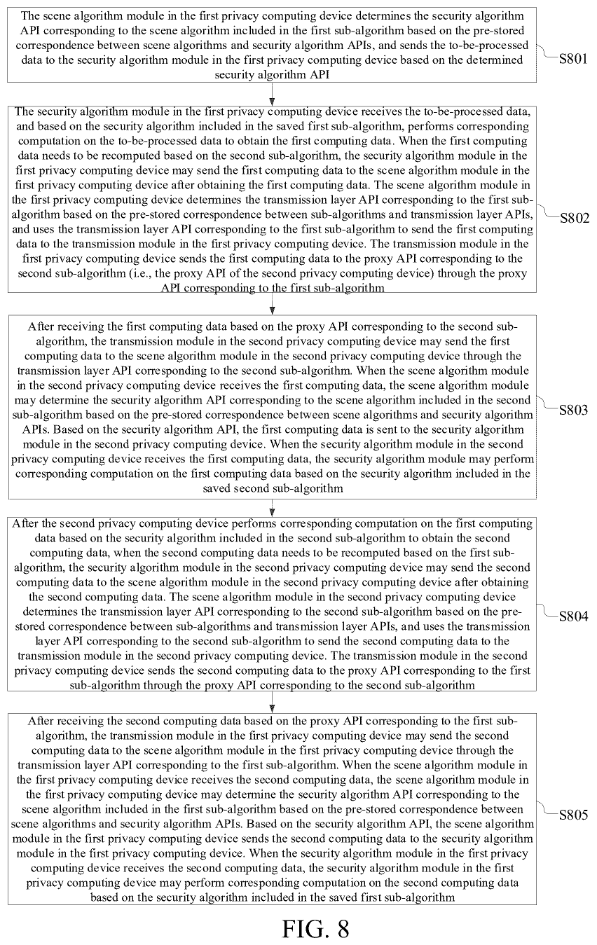

To facilitate understanding, the privacy algorithm interconnection and interoperability process provided by the embodiments of the disclosure is described below through a specific embodiment. Referring to FIGS. 7 and 8, FIG. 7 shows a schematic diagram of an interconnection scenario of different privacy algorithms according to some embodiments, and FIG. 8 shows a schematic diagram of a fifth interconnection and interoperability process between different privacy algorithms according to some embodiments. As shown in FIGS. 7 and 8, the process includes the following steps.
S801: The scene algorithm module in the first privacy computing device determines the security algorithm API corresponding to the scene algorithm included in the first sub-algorithm based on the pre-stored correspondence between scene algorithms and security algorithm APIs, and sends the to-be-processed data to the security algorithm module in the first privacy computing device based on the determined security algorithm API.
S802: The security algorithm module in the first privacy computing device receives the to-be-processed data, and based on the security algorithm included in the saved first sub-algorithm, performs corresponding computation on the to-be-processed data to obtain the first computing data. When the first computing data needs to be recomputed based on the second sub-algorithm, the security algorithm module in the first privacy computing device may send the first computing data to the scene algorithm module in the first privacy computing device after obtaining the first computing data. The scene algorithm module in the first privacy computing device determines the transmission layer API corresponding to the first sub-algorithm based on the pre-stored correspondence between sub-algorithms and transmission layer APIs, and uses the transmission layer API corresponding to the first sub-algorithm to send the first computing data to the transmission module in the first privacy computing device. The transmission module in the first privacy computing device sends the first computing data to the proxy API corresponding to the second sub-algorithm (i.e., the proxy API of the second privacy computing device) through the proxy API corresponding to the first sub-algorithm.

Optionally, the first privacy computing device and the second privacy computing device may communicate through a network.
S803: After receiving the first computing data based on the proxy API corresponding to the second sub-algorithm, the transmission module in the second privacy computing device may send the first computing data to the scene algorithm module in the second privacy computing device through the transmission layer API corresponding to the second sub-algorithm. When the scene algorithm module in the second privacy computing device receives the first computing data, the scene algorithm module may determine the security algorithm API corresponding to the scene algorithm included in the second sub-algorithm based on the pre-stored correspondence between scene algorithms and security algorithm APIs. Based on the security algorithm API, the first computing data is sent to the security algorithm module in the second privacy computing device. When the security algorithm module in the second privacy computing device receives the first computing data, the security algorithm module may perform corresponding computation on the first computing data based on the security algorithm included in the saved second sub-algorithm.
S804: After the second privacy computing device performs corresponding computation on the first computing data based on the security algorithm included in the second sub-algorithm to obtain the second computing data, when the second computing data needs to be recomputed based on the first sub-algorithm, the security algorithm module in the second privacy computing device may send the second computing data to the scene algorithm module in the second privacy computing device after obtaining the second computing data. The scene algorithm module in the second privacy computing device determines the transmission layer API corresponding to the second sub-algorithm based on the pre-stored correspondence between sub-algorithms and transmission layer APIs, and uses the transmission layer API corresponding to the second sub-algorithm to send the second computing data to the transmission module in the second privacy computing device. The transmission module in the second privacy computing device sends the second computing data to the proxy API corresponding to the first sub-algorithm through the proxy API corresponding to the second sub-algorithm.
S805: After receiving the second computing data based on the proxy API corresponding to the first sub-algorithm, the transmission module in the first privacy computing device may send the second computing data to the scene algorithm module in the first privacy computing device through the transmission layer API corresponding to the first sub-algorithm.

When the scene algorithm module in the first privacy computing device receives the second computing data, the scene algorithm module in the first privacy computing device may determine the security algorithm API corresponding to the scene algorithm included in the first sub-algorithm based on the pre-stored correspondence between scene algorithms and security algorithm APIs. Based on the security algorithm API, the scene algorithm module in the first privacy computing device sends the second computing data to the security algorithm module in the first privacy computing device. When the security algorithm module in the first privacy computing device receives the second computing data, the security algorithm module in the first privacy computing device may perform corresponding computation on the second computing data based on the security algorithm included in the saved first sub-algorithm.

In some embodiments, the security algorithm API in the first privacy computing device and the security algorithm API in the second privacy computing device may be the same API, and the transmission layer API in the first privacy computing device and the transmission layer API in the second privacy computing device may also be the same API, and the proxy API in the first privacy computing device and the proxy API in the second privacy computing device may also be the same API.

### Embodiment 4

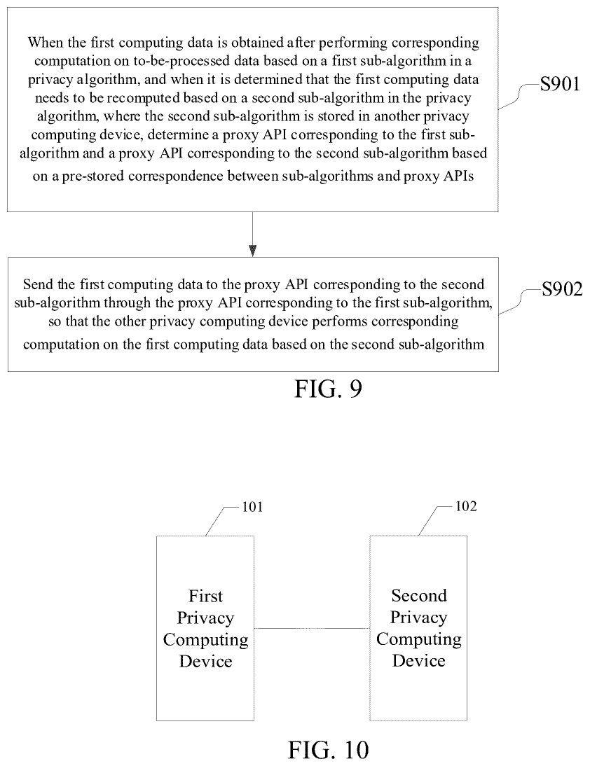

Based on the similar technical concept, the disclosure provides a privacy computing method. FIG. 9 shows a schematic process diagram of a privacy computing method according to some embodiments. As shown in FIG. 9, the method includes the following steps.
S901: When the first computing data is obtained after performing corresponding computation on to-be-processed data based on a first sub-algorithm in a privacy algorithm, and when it is determined that the first computing data needs to be recomputed based on a second sub-algorithm in the privacy algorithm, where the second sub-algorithm is stored in another privacy computing device, determining a proxy API corresponding to the first sub-algorithm and a proxy API corresponding to the second sub-algorithm based on a pre-stored correspondence between sub-algorithms and proxy APIs.
S902: Sending the first computing data to the proxy API corresponding to the second sub-algorithm through the proxy API corresponding to the first sub-algorithm, so that the other privacy computing device performs corresponding computation on the first computing data based on the second sub-algorithm.

The privacy computing method provided by the embodiments of the disclosure may be applied to an electronic device. The electronic device may be a privacy computing device that stores a privacy algorithm (e.g., sub-algorithm). The electronic device may be a device such as a PC, a mobile terminal, and the like, or may be a device such as a server and the like.

In some embodiments, before determining that the first computing data needs to be recomputed based on the second sub-algorithm in the privacy algorithm, the method further includes: receiving a transmission instruction for sending the first computing data, where the transmission instruction carries information that the first computing data needs to be sent to the second sub-algorithm.

In some embodiments, the method further includes: when the second computing data is received based on the proxy API corresponding to the first sub-algorithm, and when it is determined that the second computing data needs to be recomputed based on the first sub-algorithm, performing corresponding computation on the second computing data based on the first sub-algorithm.

In some embodiments, before determining that the second computing data needs to be recomputed based on the first sub-algorithm, the method further includes: receiving a processing instruction that the second computing data needs to be processed based on the first sub-algorithm.

In some embodiments, after receiving the processing instruction that the second computing data needs to be processed based on the first sub-algorithm, and before determining that the second computing data needs to be recomputed based on the first sub-algorithm, the method further includes: identifying a target token carried in the processing instruction, and if the target token is consistent with a pre-stored reference token of the second sub-algorithm, determining that the second computing data needs to be recomputed based on the first sub-algorithm.

### Embodiment 5

Based on the similar technical concept, the disclosure provides a privacy computing system. FIG. 10 shows a schematic diagram of a privacy computing system according to some embodiments. The system includes the following.

A first privacy computing device 101, configured to, when the first computing data is obtained after performing corresponding computation on the to-be-processed data based on the first sub-algorithm in the privacy algorithm, and when it is determined that the first computing data needs to be recomputed based on the second sub-algorithm in the privacy algorithm, where the second sub-algorithm is stored in the second privacy computing device, determine a poxy API corresponding to the first sub-algorithm and a proxy API corresponding to the second sub-algorithm based on a pre-stored correspondence between sub-algorithms and proxy APIs, and send the first computing data to the proxy API corresponding to the second sub-algorithm through the proxy API corresponding to the first sub-algorithm.

A second privacy computing device 102, configured to, when the first computing data is received based on the proxy API corresponding to the second sub-algorithm, and when it is determined that the first computing data needs to be recomputed based on the second sub-algorithm, perform corresponding computation on the first computing data based on the second sub-algorithm.

In some embodiments, the first privacy computing device 101 includes a determination unit and a transmission unit. The determination unit in the first privacy computing device 101 is configured to, when the first computing data is obtained after performing corresponding computation on the to-be-processed data based on the first sub-algorithm in the privacy algorithm, and when it is determined that the first computing data needs to be recomputed based on the second sub-algorithm in the privacy algorithm, where the second sub-algorithm is stored in another privacy computing device, determine the proxy API corresponding to the first sub-algorithm and the proxy API corresponding to the second sub-algorithm based on the pre-stored correspondence between sub-algorithms and proxy APIs. The transmission unit in the first privacy computing device 101 is configured to send the first computing data to the proxy API corresponding to the second sub-algorithm through the proxy API corresponding to the first sub-algorithm, so that the other privacy computing device performs corresponding computation on the first computing data based on the second sub-algorithm.

In some embodiments, the determination unit in the first privacy computing device 101 includes: a scene algorithm module, configured to send the to-be-processed data to a security algorithm module; and the security algorithm module, configured to receive the to-be-processed data, and perform corresponding computation on the to-be-processed data based on the security algorithm included in the saved first sub-algorithm to obtain the first computing data.

In some embodiments, the scene algorithm module in the first privacy computing device 101 is specifically configured to determine the security algorithm API corresponding to the scene algorithm included in the first sub-algorithm based on the pre-stored correspondence between scene algorithms and security algorithm APIs, and send the to-be-processed data to the security algorithm module in the first privacy computing device 101 based on the security algorithm API corresponding to the scene algorithm.

In some embodiments, the security algorithm module in the first privacy computing device 101 is further configured to send the first computing data to the scene algorithm module in the first privacy computing device 101. The scene algorithm module in the first privacy computing device 101 is further configured to send the first computing data to the transmission unit in the first privacy computing device 101.

In some embodiments, the scene algorithm module in the first privacy computing device 101 is specifically configured to determine the transmission layer API corresponding to the first sub-algorithm based on the pre-stored correspondence between sub-algorithms and transmission layer APIs, and send the first computing data to the transmission unit in the first privacy computing device 101 through the transmission layer API corresponding to the first sub-algorithm.

The security algorithm module in the first privacy computing device 101 is further configured to send the first computing data to the transmission unit in the first privacy computing device 101.

In some embodiments, the security algorithm module in the first privacy computing device 101 is specifically configured to determine the transmission layer API corresponding to the first sub-algorithm based on the pre-stored correspondence between sub-algorithms and transmission layer APIs, and send the first computing data to the transmission unit in the first privacy computing device 101 through the transmission layer API corresponding to the first sub-algorithm.

In some embodiments, the determination unit in the first privacy computing device 101 is further configured to, when a transmission instruction to send the first computing data is received, where the transmission instruction carries the information that the first computing data needs to be sent to the second sub-algorithm, determine that the first computing data needs to be recomputed based on the second sub-algorithm in the privacy algorithm.

In some embodiments, the transmission unit in the first privacy computing device 101 is further configured to, when the second computing data is received based on the proxy API corresponding to the first sub-algorithm, send the second computing data to the determination unit in the first privacy computing device 101. The determination unit in the first privacy computing device 101 is further configured to, when it is determined that the second computing data needs to be recomputed based on the first sub-algorithm, perform corresponding computation on the second computing data based on the first sub-algorithm.

In some embodiments, the transmission unit in the first privacy computing device 101 is specifically configured to, when the second computing data is received, send the second computing data to the determination unit in the first privacy computing device 101 through the transmission layer API corresponding to the first sub-algorithm.

In some embodiments, the determination unit in the first privacy computing device 101 includes that the scene algorithm module in the first privacy computing device 101 is specifically configured to receive the second computing data and send the second computing data to the security algorithm module in the first privacy computing device 101, and that the security algorithm module in the first privacy computing device 101 is specifically configured to receive the second computing data, and perform corresponding computation on the second computing data based on the security algorithm included in the saved first sub-algorithm.

In some embodiments, the scene algorithm module in the first privacy computing device 101 is specifically configured to determine the security algorithm API corresponding to the scene algorithm included in the first sub-algorithm based on the pre-stored correspondence between scene algorithms and security algorithm APIs, and send the second computing data to the security algorithm module in the first privacy computing device 101 based on the security algorithm API corresponding to the scene algorithm.

In some embodiments, the determination unit in the first privacy computing device 101 is further configured to determine that the second computing data needs to be recomputed based on the first sub-algorithm when a processing instruction indicating that the second computing data needs to be processed based on the first sub-algorithm is received.

In some embodiments, the determination unit in the first privacy computing device 101 is further configured to identify a target token carried in the processing instruction. When the target token and the pre-stored reference token of the second sub-algorithm are consistent, it is determined that the second computing data needs to be recomputed based on the first sub-algorithm.

In some embodiments, the first sub-algorithm and the second sub-algorithm are container-structured algorithms.

In some embodiments, the second privacy computing device 102 includes a determination unit and a transmission unit, where the transmission unit in the second privacy computing device 102 is configured to receive the first computing data based on the proxy API corresponding to the second sub-algorithm, and send the first computing data to the determination unit in the second privacy computing device 102. The determination unit in the second privacy computing device 102 is configured to, when it is determined that the first computing data needs to be recomputed based on the second sub-algorithm stored in the privacy algorithm, perform corresponding computation on the first computing data based on the second sub-algorithm.

In some embodiments, the transmission unit in the second privacy computing device 102 is further configured to send the first computing data, through the transmission layer API corresponding to the second sub-algorithm, to the determination unit in the second privacy computing device 102 when the first computing data is received.

The determination unit in the second privacy computing device 102 includes that the scene algorithm module in the second privacy computing device 102 is further configured to receive the first computing data, determine the security algorithm API corresponding to the scene algorithm included in the second sub-algorithm according to the pre-stored correspondence between scene algorithms and security algorithm APIs, and send the first computing data to the security algorithm module in the second privacy computing device 102 based on the security algorithm API. The security algorithm module in the second privacy computing device 102 is specifically configured to receive the first computing data, and perform corresponding computation on the first computing data based on the security algorithm included in the saved second sub-algorithm.

In some embodiments, the determination unit in the second privacy computing device 102 is further configured to, when a processing instruction that the first computing data needs to be processed based on the second sub-algorithm is received, determine that the first computing data needs to be recomputed based on the second sub-algorithm.

In some embodiments, the determination unit in the second privacy computing device 102 is further configured to identify a target token carried in the processing instruction.

When the target token and the pre-stored reference token of the first sub-algorithm are consistent, it is determined that the first computing data needs to be recomputed based on the second sub-algorithm.

### Embodiment 6

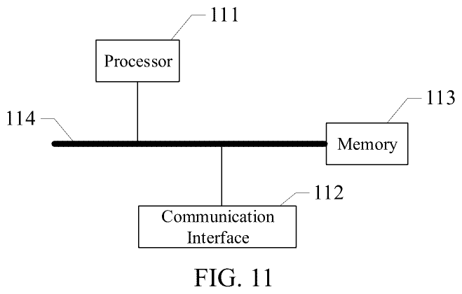

Based on the similar technical concept, the disclosure also provides an electronic device. FIG. 11 shows a schematic structural diagram of an electronic device according to some embodiments. As shown in FIG. 11, the electronic device includes a processor 111, a communication interface 112, a memory 113, and a communication bus 114, where the processor 111, communication interface 112, and memory 113 complete communication with each other through the communication bus 114.

The memory 113 stores a computer program. When the computer program is executed by the processor 111, the processor 111 performs the following steps.

When the first computing data is obtained after performing corresponding computation on to-be-processed data based on the first sub-algorithm in the privacy algorithm, and when it is determined that the first computing data needs to be recomputed based on the second sub-algorithm in the privacy algorithm, where the second sub-algorithm is stored in another privacy computing device, determining a proxy API corresponding to the first sub-algorithm and a proxy API corresponding to the second sub-algorithm based on the pre-stored correspondence between sub-algorithms and proxy APIs; and sending the first computing data to the proxy API corresponding to the second sub-algorithm through the proxy API corresponding to the first sub-algorithm, so that the other privacy computing device performs corresponding computation on the first computing data based on the second sub-algorithm.

In some embodiments, before the processor 111 is further configured to determine that the first computing data needs to be recomputed based on the second sub-algorithm in the privacy algorithm, the method further includes: receiving a transmission instruction for sending the first computing data, where the transmission instruction carries information that the first computing data needs to be sent to the second sub-algorithm.

In some embodiments, the processor 111 is further configured to, when second computing data is received based on the proxy API corresponding to the first sub-algorithm, and when it is determined that the second computing data needs to be recomputed based on the first sub-algorithm, perform corresponding computation on the second computing data based on the first sub-algorithm.

In some embodiments, before the processor 111 is further configured to determine that the second computing data needs to be recomputed based on the first sub-algorithm, the method further includes: receiving a processing instruction that the second computing data needs to be processed based on the first sub-algorithm.

In some embodiments, after the processor 111 is further configured to receive a processing instruction to process the second computing data based on the first sub-algorithm and before determining that the second computing data needs to be recomputed based on the first sub-algorithm, the method further includes: identifying a target token carried in the processing instruction, and when the target token is consistent with the pre-stored reference token of the second sub-algorithm, performing the subsequent step of determining that the second computing data needs to be recomputed based on the first sub-algorithm.

Since the problem-solving principle of the aforementioned electronic device is similar to that of the privacy computing methods, the implementation of the electronic device may be referred to the implementation of the privacy computing methods, details of which will not be repeated here.

The communication bus in the aforementioned electronic equipment may be a peripheral component interconnect (PCI) bus or an extended industry standard architecture (EISA) bus, etc. The communication bus may be divided into address bus, data bus, control bus, etc. For ease of presentation, merely one thick line is used in the figure, but it does not mean that there is just one bus or one type of bus.

The communication interface 112 is configured for communication between the aforementioned electronic device and other devices.

The memory may include random access memory (RAM) or non-volatile memory (NVM), such as at least one disk memory. Optionally, the memory may also be at least one storage device located remotely from the aforementioned processor.

The processor may be a general-purpose processor, including a central processing unit, a network processor (NP), etc. The processor may also be a digital instruction processor (DSP), an application-specific integrated circuit, a field programmable gate array, or other programmable logic devices, discrete gate or transistor logic devices, discrete hardware components, etc.

### Embodiment 7

Based on the similar technical concept, embodiments of the present disclosure provide a computer-readable storage medium. The computer-readable storage medium stores a computer program that may be executed by an electronic device. When the program is run on the electronic device, the electronic device may implement the following steps.

When first computing data is obtained after performing corresponding computation on to-be-processed data based on a first sub-algorithm in a privacy algorithm, and when it is determined that the first computing data needs to be recomputed based on a second sub-algorithm in the privacy algorithm, where the second sub-algorithm is stored in another privacy computing device, determining a proxy API corresponding to the first sub-algorithm and a proxy API corresponding to the second sub-algorithm based on a pre-stored correspondence between sub-algorithms and proxy APIs; and sending the first computing data to the proxy API corresponding to the second sub-algorithm through the proxy API corresponding to the first sub-algorithm, so that the other privacy computing device performs corresponding computation on the first computing data based on the second sub-algorithm.

In some embodiments, before determining that the first computing data needs to be recomputed based on the second sub-algorithm in the privacy algorithm, the method further includes: receiving a transmission instruction for sending the first computing data, where the transmission instruction carries information that the first computing data needs to be sent to the second sub-algorithm.

In some embodiments, the method further includes: when the second computing data is received based on the proxy API corresponding to the first sub-algorithm, and when it is determined that the second computing data needs to be recomputed based on the first sub-algorithm, performing corresponding computation on the second computing data based on the first sub-algorithm.

In some embodiments, before determining that the second computing data needs to be recomputed based on the first sub-algorithm, the method further includes: receiving a processing instruction that the second computing data needs to be processed based on the first sub-algorithm.

In some embodiments, after receiving the processing instruction that the second computing data needs to be processed based on the first sub-algorithm, and before determining that the second computing data needs to be recomputed based on the first sub-algorithm, the method also includes: identifying a target token carried in the processing instruction, and when the target token is consistent with a pre-stored reference token of the second sub-algorithm, performing the subsequent step of determining that the second computing data needs to be recomputed based on the first sub-algorithm.

Since the problem-solving principle of the above computer-readable storage medium is similar to the privacy computing methods, the implementation of the aforementioned computer-readable storage medium may be referred to the implementation of the privacy computing methods, details of which will not be repeated here.

The computer-readable storage media may be any available media or data storage devices that may be accessed by the processor in the electronic device, including but not limited to magnetic memories such as floppy disks, hard disks, magnetic tapes, magneto-optical (MO) disks, and optical memories such as CD, DVD, blue-ray disc (BD), holographic versatile disc (HVD), and so on, as well as semiconductor memories such as ROM, EPROM, EEPROM, non-volatile memory (e.g., NAND FLASH), solid state drive (SSD), etc.

Based on the similar technical concept and on the basis of the above embodiments, the present disclosure provides a computer program product. The computer program product includes computer program code. When the computer program code is run on a computer, the computer performs the steps of the privacy computing methods described above.

Those skilled in the art will understand that embodiments of the present disclosure may be provided as methods, systems, or computer program products. Accordingly, the present disclosure may take the form of an entirely hardware embodiment, an entirely software embodiment, or an embodiment that combines software and hardware aspects. Furthermore, the present disclosure may take the form of a computer program product embodied on one or more computer-usable storage media (including, but not limited to, disk storage, CD-ROM, optical storage, etc.) having computer-usable program code embodied therein.

The present disclosure is described with reference to flowchart illustrations and/or block diagrams of methods, apparatus (systems), and computer program products according to the present disclosure. It will be understood that each process and/or block in the flowchart illustrations and/or block diagrams, and combinations of processes and/or blocks in the flowchart illustrations and/or block diagrams, may be implemented by computer program instructions.

These computer program instructions may be provided to a processor of a general purpose computer, special purpose computer, embedded processor, or other programmable data processing device to form a machine, such that the instructions executed by the processor of the computer or other programmable data processing devices produce a device for realizing the functions specified in one process or multiple processes of a flowchart and/or one block or multiple blocks of a block diagram.

These computer program instructions may also be stored in a computer-readable memory that causes a computer or other programmable data processing apparatus to operate in a particular manner, such that the instructions stored in the computer-readable memory produce an article of manufacture including the instruction means. The instruction means implements the functions specified in a process or processes of a flowchart and/or a block or blocks of a block diagram.

These computer program instructions may also be loaded onto a computer or other programmable data processing device, causing a series of operating steps to be performed on the computer or other programmable device to produce computer-implemented processing, thereby executing on the computer or other programmable device. Instructions provide steps for implementing the functions specified in a process or processes of a flowchart diagram and/or a block or blocks of a block diagram.

Apparently, those skilled in the art may make various changes and modifications to the present disclosure without departing from the spirit and scope of the present disclosure. Accordingly, if these modifications and variations of the present disclosure fall within the scope of the claims of the present disclosure and equivalent technologies, the present disclosure is also intended to include these modifications and variations.

1. A privacy computing device, comprising:
a determination unit, configured to, when first computing data is obtained after performing corresponding computation on to-be-processed data based on a first sub-algorithm in a privacy algorithm, and when it is determined that the first computing data needs to be recomputed based on a second sub-algorithm in the privacy algorithm, wherein the second sub-algorithm is stored in another privacy computing device, determine a proxy application programming interface (API) corresponding to the first sub-algorithm and a proxy API corresponding to the second sub-algorithm according to a pre-stored correspondence between sub-algorithms and proxy APIs; and
a transmission unit, configured to send the first computing data to the proxy API corresponding to the second sub-algorithm through the proxy API corresponding to the first sub-algorithm, so that the other privacy computing device performs corresponding computation on first computing data based on the second sub-algorithm.

2. The device according to claim 1, wherein the determination unit includes:
a scene algorithm module, configured to send the to-be-processed data to a security algorithm module; and
the security algorithm module, configured to receive the to-be-processed data, and perform the corresponding computation on the to-be-processed data based on a security algorithm included in the first sub-algorithm to obtain the first computing data.

3. The device according to claim 2, wherein the scene algorithm module is further configured to determine a security algorithm API corresponding to the scene algorithm included in the first sub-algorithm based on a pre-stored correspondence between scene algorithms and security algorithm APIs, and send the to-be-processed data to the security algorithm module based on the security algorithm API corresponding to the scene algorithm.

4. The device according to claim 2, wherein:
the security algorithm module is further configured to send the first computing data to the scene algorithm module; and
the scene algorithm module is further configured to send the first computing data to the transmission unit.

5. The device according to claim 4, wherein the scene algorithm module is further configured to determine a transmission layer API corresponding to the first sub-algorithm according to a pre-stored correspondence between sub-algorithms and transmission layer APIs, and send the first computing data to the transmission unit through the transmission layer API corresponding to the first sub-algorithm.

6. The device according to claim 2, wherein the security algorithm module is further configured to send the first computing data to the transmission unit.

7. The device according to claim 6, wherein the security algorithm module is further configured to determine a transmission layer API corresponding to the first sub-algorithm based on a pre-stored correspondence between sub-algorithms and transmission layer APIs, and send the first computing data to the transmission unit through the transmission layer API corresponding to the first sub-algorithm.

8. The device according to claim 1, wherein the determination unit is further configured to, when receiving a transmission instruction to send the first computing data, determine that the first computing data needs to be re-calculated based on the second sub-algorithm in the privacy algorithm, wherein the transmission instruction carries information that the first computing data needs to be sent to the second sub-algorithm.

9. The device according to claim 3, wherein:
the transmission unit is further configured to, when second computing data is received based on the proxy API corresponding to the first sub-algorithm, send the second computing data to the determination unit through a transmission layer API corresponding to the first sub-algorithm; and
the determination unit is further configured to perform corresponding computation on the second computing data based on the first sub-algorithm when it is determined that the second computing data needs to be recomputed based on the first sub-algorithm.

10. (canceled)

11. The device according to claim 9, wherein:
the scene algorithm module in the determination unit is further configured to receive the second computing data and send the second computing data to the security algorithm module; and
the security algorithm module in the determination unit is further configured to receive the second computing data, and perform the corresponding computation on the second computing data based on the security algorithm included in the first sub-algorithm.

12. The device according to claim 11, wherein the scene algorithm module is further configured to determine a security algorithm API corresponding to the scene algorithm included in the first sub-algorithm according to the pre-stored correspondence between the scene algorithms and the security algorithm APIs, and send the second computing data to the security algorithm module based on the security algorithm API corresponding to the scene algorithm.

13. The device according to claim 9, wherein the determination unit is further configured to determine that the second computing data needs to be recomputed based on the first sub-algorithm, when receiving a processing instruction that the second computing data needs to be processed based on the first sub-algorithm.

14. The device according to claim 13, wherein the determination unit is further configured to identify a target token carried in the processing instruction, and determine that the second computing data needs to be recomputed based on the first sub-algorithm when the target token is consistent with a pre-stored reference token of the second sub-algorithm.

15. The device according to claim 1, wherein the first sub-algorithm and the second sub-algorithm are algorithms with a container structure.

16. A privacy computing method, comprising:
when first computing data is obtained after performing corresponding computation on to-be-processed data based on a first sub-algorithm in a privacy algorithm, and when it is determined that the first computing data needs to be recomputed based on a second sub-algorithm in the privacy algorithm, wherein the second sub-algorithm is stored in another privacy computing device, determining a proxy application programming interface (API) corresponding to the first sub-algorithm and a proxy API corresponding to the second sub-algorithm based on a pre-stored correspondence between sub-algorithms and proxy APIs; and
transmitting the first computing data to the proxy API corresponding to the second sub-algorithm through the proxy API corresponding to the first sub-algorithm, so that the other privacy computing device performs corresponding computation on the first computing data based on the second sub-algorithm.

17. The method according to claim 16, wherein, before determining that the first computing data needs to be recomputed based on the second sub-algorithm in the privacy algorithm, the method further comprises:
receiving a transmission instruction for transmitting the first computing data, wherein the transmission instruction carries information that the first computing data needs to be sent to the second sub-algorithm.

18. The method according to claim 16, further comprising:
when second computing data is received based on the proxy API corresponding to the first sub-algorithm, and when it is determined that the second computing data needs to be recomputed based on the first sub-algorithm, performing corresponding computation on the second computing data based on the first sub-algorithm.

19. The method according to claim 18, wherein, before determining that the second computing data needs to be recomputed based on the first sub-algorithm, the method further comprises:
receiving a processing instruction that the second computing data needs to be processed based on the first sub-algorithm.

20. The method according to claim 19, wherein, after receiving the processing instruction that the second computing data needs to be processed based on the first sub-algorithm and before determining that the second computing data needs to be recomputed based on the first sub-algorithm, the method further comprises:
identifying a target token carried in the processing instruction, and when the target token is consistent with a pre-stored reference token of the second sub-algorithm, determining that the second computing data needs to be recomputed based on the first sub-algorithm.

21. A privacy computing system, comprising:
a first privacy computing device, configured to, when first computing data is obtained after performing corresponding computation on to-be-processed data based on a first sub-algorithm in a privacy algorithm, and when it is determined that that the first computing data needs to be recomputed based on a second sub-algorithm in the privacy algorithm, wherein the first sub-algorithm and the second sub-algorithm is stored in a second privacy computing device, determine a proxy application programming interface (API) corresponding to the first sub-algorithm and a proxy API corresponding to the second sub-algorithm according to a pre-stored correspondence between sub-algorithms and proxy APIs, and send the first computing data to the proxy API corresponding to the second sub-algorithm through the proxy API corresponding to the first sub-algorithm; and
the second privacy computing device, configured to, when receiving the first computing data based on the proxy API corresponding to the second sub-algorithm, and when it is determined that the first computing data needs to be recomputed based on the second sub-algorithm, perform corresponding computation on the first computing data based on the second sub-algorithm.

22. (canceled)

23. (canceled)
